(19) United States
(12) Patent Application Publication
(10) Pub. No.: US 2013/0018767 A1
(43) Pub. Date: Jan. 17, 2013

(54) APPARATUS AND METHOD FOR ACQUIRING CLIENT DATA TO PROCESS A FINANCIAL ACCOUNT

(71) Applicants: Simon Williams, Walnut Creek, CA (US); Zachary H. Lynde, Austin, TX (US)

(72) Inventors: Simon Williams, Walnut Creek, CA (US); Zachary H. Lynde, Austin, TX (US)

(73) Assignees: Gray Hawk Payment Technologies, Inc., Austin, TX (US); AccountNow, Inc., San Ramon, CA (US)

(21) Appl. No.: 13/180,994

(22) Filed: Jul. 12, 2011

(51) Int. Cl. G06Q 40/00

(52) U.S. Cl. 705/35

(57) ABSTRACT

A method for acquiring data to process a financial account is provided which includes receiving a request to process the financial account. The request includes a print stream of data for a client received in a print protocol. The method further includes converting the print stream of data into wire format data, and transmitting the wire format data to a server to process the financial account. A method is provided for processing a financial account which includes receiving a request from a client to process the financial account. The request includes a print stream of data for a client received in a print protocol. The method further includes extracting data elements from the received wire format data, and processing the financial account using the extracted data elements. The receiving includes receiving encrypted wire format data which has been converted from the print stream of data for the client received in a print protocol.

### BACKGROUND

1. Field:

Embodiments of the invention relate to acquiring client data to process a financial account using a system capable of printing data. More specifically, certain embodiments of the invention are directed to a system, apparatuses, methods, and computer program products for acquiring client data to process a financial account using a print stream of data received in a print protocol.

2. Description of the Related Art

Creating and managing secure financial accounts, such as bank, prepaid, payroll, debit card or credit card accounts, requires certain personal identification information, such as name, address, date of birth, social security number, etc. In addition to being manually entered, this information may reside in computer applications, such as human resource, marketing, accounting, payroll, or customer relationship management (CRM) systems. Extracting information from these computer applications requires some level of hardware and software integration to extract the data directly from databases of these systems and to send the extracted data to an application program interface (API) for creating or managing the secure financial account because each system stores and manages the data in a different manner. In some conventional systems, data may be extracted and exchanged in files via a file transfer protocol (FTP) or other protocols.

Conventional solutions for extracting information from these computer applications require hardware and/or custom software development, deployment, and maintenance based on the type of computer application and/or type of recurring operational activities being used, e.g., extracting and sending files. Thus, these conventional solutions for data extraction lack the ability to extract client data from databases of various computer applications without the need for the integration of additional hardware and customized software components into an existing system.

### SUMMARY

In accordance with an embodiment of the invention, there is provided a method for acquiring data to process a financial account, which includes receiving a request to process the financial account. The request includes a print stream of data for a client received in a print protocol. The method further includes converting the print stream of data into wire format data, and transmitting the wire format data to a server to process the financial account.

In accordance with another embodiment of the invention, there is provided an apparatus, which includes a receiver configured to receive a request to process a financial account. The request includes a print stream of data for a client received in a print protocol. The apparatus further includes a processor configured to convert the print stream of data into wire format data. Further, the apparatus includes a transmitter configured to transmit the wire format data to a server for processing the financial account.

In accordance with another embodiment of the invention, there is provided an apparatus, which includes receiving means for receiving a request to process a financial account. The request includes a print stream of data for a client received in a print protocol. The apparatus further includes processing means for converting the print stream of data into wire format data. Further, the apparatus includes transmitting means for transmitting the wire format data to a server for processing the financial account.

In accordance with another embodiment of the invention, there is provided a method for processing a financial account, which includes receiving a request to process the financial account. The request includes wire format data for a client. The method further includes extracting data elements from the received wire format data, and processing the financial account using the extracted data elements. The receiving includes receiving encrypted wire format data which has been converted from a print stream of data for the client received in a print protocol.

In accordance with another embodiment of the invention, there is provided an apparatus, which includes a receiver configured to receive a request to process a financial account. The request includes wire format data for a client. The apparatus further includes an extractor configured to extract data elements from the received wire format data, and a processor configured to process the financial account using the extracted data elements. The data includes encrypted wire format data which has been converted from a print stream of data for the client received in a print protocol.

In accordance with another embodiment of the invention, there is provided an apparatus, which includes receiving means for receiving a request to process a financial account. The request includes wire format data for a client. The apparatus further includes extracting means for extracting data elements from the received wire format data, and processing means for processing the financial account using the extracted data elements. The data includes encrypted wire format data which has been converted from a print stream of data for the client received in a print protocol.

In accordance with another embodiment of the invention, there is provided a computer program product embodied on a non-transitory computer readable storage medium. The computer program product is encoded with instructions to control a processor to perform a process for acquiring data to process a financial account. The process includes receiving a request to process the financial account. The request includes a print stream of data for a client received in a print protocol. The process further includes converting the print stream of data into wire format data. Further, the process includes transmitting the wire format data to a server to process the financial account.

In accordance with another embodiment of the invention, there is provided a computer program product embodied on a non-transitory computer readable storage medium. The computer program product is encoded with instructions to control a processor to perform a process for processing a financial account. The process includes receiving a request to process the financial account. The request includes wire format data for a client. The process further includes extracting data elements from the received wire format data, and processing the financial account using the extracted data elements. The receiving includes receiving encrypted wire format data which has been converted from a print stream of data for the client received in a print protocol.

### BRIEF DESCRIPTION OF DRAWINGS

Further aspects, details, advantages and modifications of the invention will become apparent from the following detailed description of the embodiments, which is to be taken in conjunction with the accompanying drawings, in which:

FIG. 1 shows a block diagram of a system, in accordance with an embodiment of the invention.

FIG. 2 shows a block diagram of an apparatus, in accordance with an embodiment of the invention.

FIG. 3 shows a flow diagram of a method for acquiring data for processing a financial account, in accordance with an embodiment of the invention.

FIG. 4 shows a block diagram of another apparatus, in accordance with an embodiment of the invention.

FIG. 5 shows a flow diagram of a method for processing a financial account, in accordance with an embodiment of the invention.

FIG. 6 shows a flow diagram of another method for processing a financial account, in accordance with an embodiment of the invention.

FIG. 7 shows a schematic diagram of user management features, in accordance with an embodiment of the invention

FIG. 8 shows a flow diagram of a method for processing a queued request, in accordance with an embodiment of the invention.

FIG. 9 shows a flow diagram of a method for cancelling a financial account, in accordance with an embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of a system, apparatuses, methods, and computer program products, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the use of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” or other similar language, throughout this specification do not necessarily all refer to the same group of embodiments, and the described features, structures, or characteristics may be combined in any suitable manner in one or more embodiments.

If desired, the different functions discussed below may be performed in a different order and/or concurrently with each other. Furthermore, if desired, one or more of the above-described functions may be optional or may be combined. As such, the foregoing description should be considered as merely illustrative of the principles, teachings and embodiments of this invention, and not in limitation thereof.

Some embodiments of the invention combine hardware and software components to create a system, apparatuses, methods, and computer program products for either acquiring data to process a financial account or for processing the financial account. In particular, certain embodiments of the invention provide for acquiring client data from databases of various computer applications using postscript printing and for converting the postscript data into readable text for transmission to a host server for processing of the financial account, as will be discussed in more detail below.

In accordance with an embodiment of the invention, there are “client” applications (e.g., a user interface of which a graphical user interface and a third party widget are examples) and a server application, such that multiple clients can interact with the server through the API that uses an application-agnostic “wire format,” such as an extensible markup language-remote procedure calling protocol (XML-RPC), a simple object access protocol (SOAP), or representational state transfer (REST). Therefore, an embodiment of the invention allows one or more users to implement “client” applications that interact with an apparatus (e.g., a server), as will be discussed below in more detail, thereby creating a distributed computing environment for extraction of user data from various customer applications, such as human resource, marketing, accounting, payroll, or CRM systems or client databases/accounts as API clients (hereinafter referred to as “client” or “customer”).

In accordance with an embodiment of the invention, the distributed computing environment may be used in conjunction with an inmate processing system. For example, data from a printer may be used to create financial accounts for inmates being released from incarceration. In another embodiment, the distributed computing environment may be used in conjunction with a payroll system for a restaurant. For example, a restaurant owner who owns a restaurant with a high staff turnover rate may offer employees a prepaid payroll card account to avoid dealing with checks or cash payroll payments each week. The human resources payroll system of the restaurant would be configured to “print” information for an employee using a print protocol which would automatically initiate that employee's enrollment into a prepaid card account for which wages are directly deposited. The distributed computing environment may be used in conjunction with a payroll system for seasonal workers. Instead of using checks and cash payroll payments each week, an employer could issue an instant issue card account (i.e., a one-time reloadable card) using an Excel spreadsheet of employee information to “print” information for an employee using a print protocol which would automatically upload wages directly into the instant issue card account.

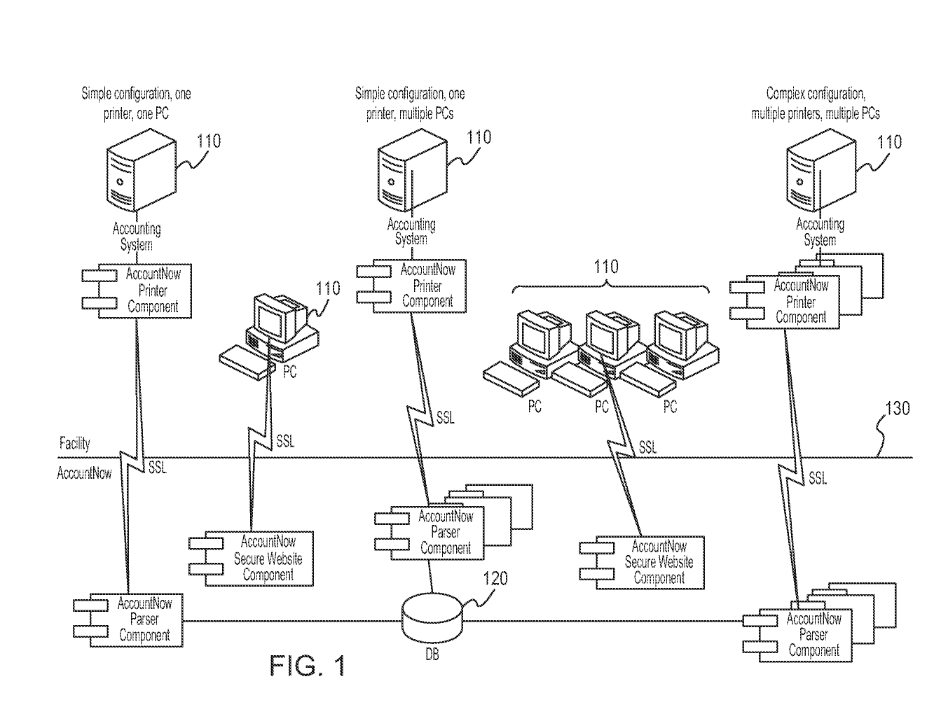

FIG. 1 shows a block diagram of a system, in accordance with an embodiment of the invention. The system 100 includes a client device 110 and a host server 120. The client device 110 may include a single computer and a single printer, a plurality of computers and a single printer, or a plurality of computers and printers. The following detailed description of various embodiments of the invention will collectively refer to a single client device 110 and a plurality of client devices 110 as “the client device 110.”

In accordance with an embodiment of the invention, the client device 110 includes any system and/or device, or combination of systems and/or devices that is capable of establishing a connection, wired or wireless, with another system, device, or server. For example, the client device 110 may include a personal computer (e.g., a server desktop or a desktop computer), a computer cluster, or a mobile computing device (e.g., a notebook, a laptop computer, a handheld computer, a handheld device, such as a mobile unit, a cellular telephone, a smart phone, a personal digital assistant (PDA)), having wired or wireless communication capabilities, or a portable unit or a terminal that incorporates combinations of such functions, as non-limiting examples.

In accordance with an embodiment of the invention, the client device 110 is coupled to the host server 120 through a network 130, while in another embodiment of the invention the client device 110 is directly connected to another client device 110 and/or the host server 120.

The network 130, over which one or more client devices 110 are coupled, may include one or more networks which provide wired or wireless connectivity between the one or more client devices 110 and the host server 120. The network 130 may include an open network, for example, the Internet, or a private network, for example, an intranet and/or an extranet. In accordance with certain embodiments of the invention, communications between the one or more client devices 110 and the host server 120 is secured using an encrypted communication protocol, for example, a secure sockets layer (SSL) or a transport layer security (TLS). The Internet may provide file transfer, remote login, email, news, RSS, and other services through any known or convenient protocol, such as TCP/IP protocol, Open System Interconnections (OSI), FTP, UPnP, iSCSI, NSF, ISDN, PDH, RS-232, SDH, SONET, as non-limiting examples.

The term “Internet” refers to a network of networks that uses certain protocols, for example, a TCP/IP protocol, a hypertext transfer protocol (HTTP) for hypertext markup language (HTML) documents that make up the World Wide Web (the web). Content is provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to a person of ordinary skill in the relevant art.

In accordance with an embodiment of the invention, communications between the client device 110 and the host server 120 may be achieved via one or more wireless networks, such as one or more local area network (LAN), wireless local area network (WLAN), personal area network (PAN), campus area network (CAN), metropolitan area network (MAN), wide area network (WAN), wireless wide area network (WWAN), global system for mobile communications (GSM), personal communications service (PCS), digital advanced mobile phone service (D-Amps), Bluetooth, Wi-Fi, fixed wireless data, 2G, 2.5G, 3G, or 4G network, enhanced data rates for GSM evolution (EDGE), general packet ratio service (GPRS), enhanced GPRS, messaging protocols, such as TCP/IP, SMS, MMS, extensible message and presence protocol (XMPP), real time messaging protocol (RTMP), instant messaging and presence protocol (IMPP), instant messaging, USSD, IRC, or any other wireless data networks or messaging protocols.

The client device 110 may be coupled to the network 130 (e.g., the Internet) via a dial-up connection, a digital subscriber loop (DSL, ADSL), cable modem, and/or other type of connection. As a result, the client device 110 may communicate with remote servers (e.g., web servers, host server, mail server, and instant messaging server) that provide access to user interfaces of the World Wide Web via a web browser, for example.

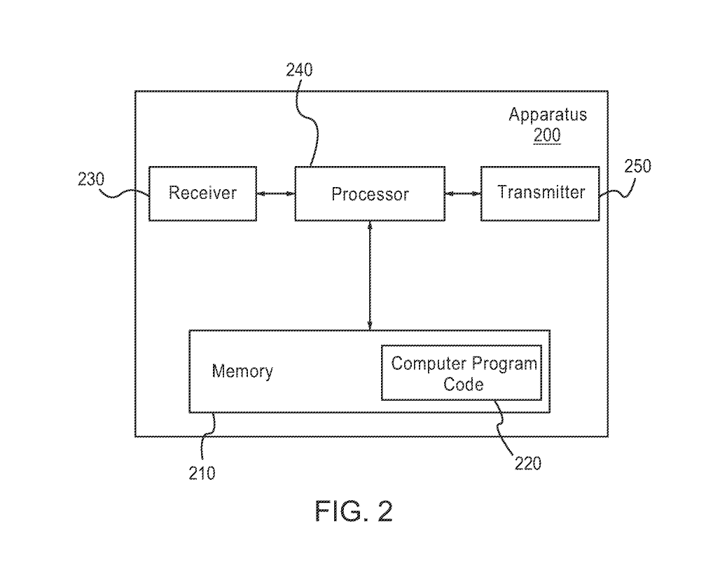

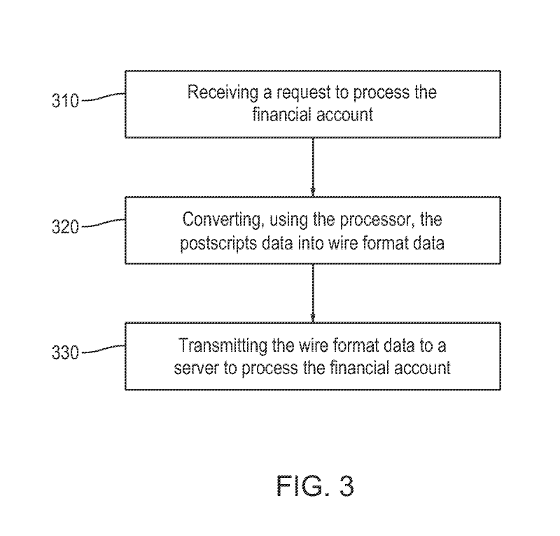

In accordance with an embodiment of the invention, the client device 110, as will be discussed in more detail below with respect to FIGS. 2 and 3, is configured to acquire client data from various applications for processing a financial account. The client device 110 includes various combinations of hardware, firmware, and software embodied on a non-transitory computer readable medium or computer-readable storage medium. For example, in accordance with an embodiment of the invention, the client device 110 is configured for converting a print stream of data received in a print protocol to wire format data, as discussed above. In operation, the client device 110 receives a print stream from an application (e.g., a computer application). The application may include, for example, a human resource, marketing, accounting, payroll, or CRM system, as non-limiting examples, which includes personal identification information of an individual (i.e., the client). The client device 110 converts the print stream of data into wire format data (i.e., a readable text) for transmission. The client device 110 transmits the wire format data to the host server 120 to process the financial account. In accordance with an embodiment of the invention, processing the financial account by the host server 120 includes generating a new financial account, modifying an existing financial account, loading funds into the existing financial account, and deleting or cancelling the existing financial account, as will be discussed in more detail below.

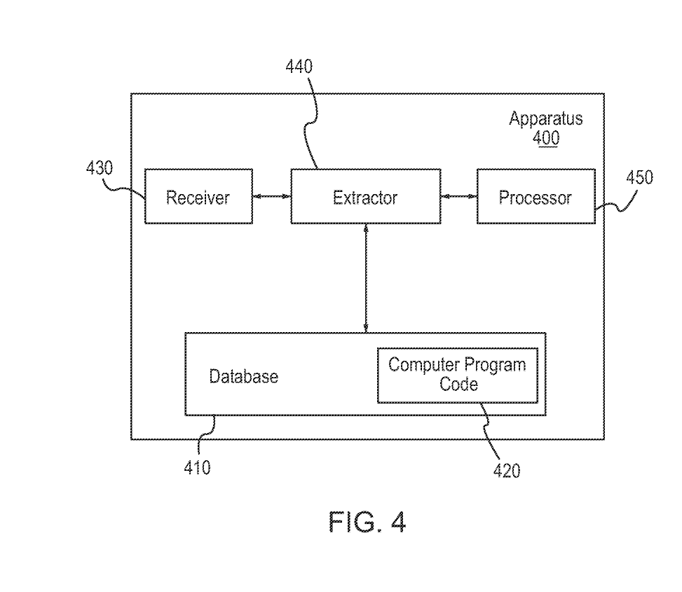

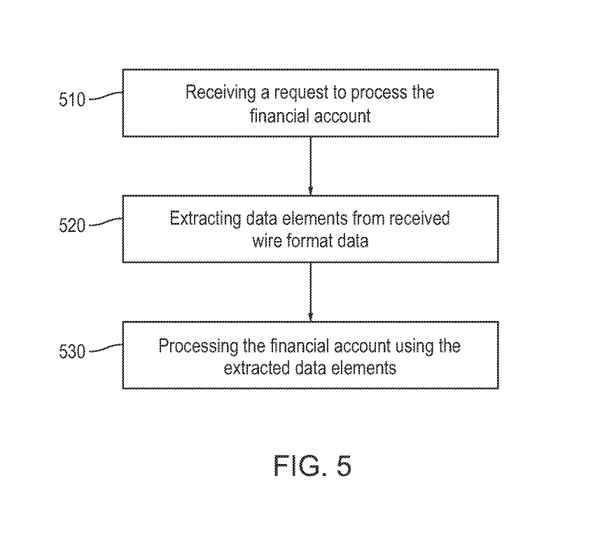

In accordance with an embodiment of the invention, the host server 120, as will be discussed in more detail below with respect to FIGS. 4 and 5, is configured to process the financial account based on data elements extracted from the wire format data received from the client device 110. In accordance with an embodiment of the invention, the host server 120 receives the wire format data from the client device 110. Using a client identifier (i.e., a profile of the client) included in the wire format data received from the client device 110, the host server 120 extracts data elements from the wire format data based on the client identifier. The extracted data elements are used to process the financial account. The extracted data elements are submitted to an API of the host server 120 to generate the new financial account, modify the existing financial account, load funds into the existing financial account, or delete or cancel the existing financial account. In accordance with an embodiment of the invention, the host server 120 may further include a web-based, graphical user interface through which the client or a user of the client device 110 manages the processing of the financial account, as will be discussed in more detail below.

FIG. 2 shows a block diagram of an apparatus, in accordance with an embodiment of the invention. In accordance with an embodiment of the invention, the apparatus 200 includes a memory 210 including computer program code 220. The computer program code 220 may be embodied on a non-transitory computer-readable medium or computer-readable storage medium. The apparatus 200 also includes a receiver 230, a processor 240 for processing information and executing instructions or operations, and a transmitter 250. The memory 210 may be coupled to the processor 240 for storing information and instructions to be executed by the processor 240. The computer program code 220 may be encoded with instructions to control the receiver 230, the processor 240, and the transmitter 250 to perform a process, such as the method shown in FIG. 3, as will be discussed in more detail below.

While a single memory 210, receiver 230, processor 240, and transmitter 250 are shown in FIG. 2, multiple memory, receivers, processors, and transmitters may be utilized according to other embodiments of the invention.

In accordance with an embodiment of the invention, the receiver 230 is configured to receive a request to process a financial account. The request includes a print stream of data for a client received in a print protocol. The financial account may include one of a bank account, prepaid card account, a payroll account, a debit card account, and a credit card account. The data may include, for example, client identification information including at least one of the client's name, address, date of birth, social security number, or phone number, as non-limiting examples. The client may include the individual for whom the financial account is being created, modified, loaded with additional funds, or cancelled, or may include a user of the client device 110 managing the financial account for the client. The print protocol may include, for example, printer command language (PCL), Internet printing protocol (IPP), line printer daemon (LPD) protocol, as non-limiting examples.

The processor 240 is configured to convert the print stream of data into wire format data (i.e readable text) for transmission. The transmitter 250 transmits the wire format data to a server (e.g., the host server 120) to process the financial account.

In accordance with another embodiment of the invention, the receiver 230 is further configured to receive the request, where the request includes at least one of a command and a transaction amount. The command may include an instruction to generate a new financial account, modify the financial account, load funds into the financial account, or close the financial account.

In accordance with another embodiment of the invention, the transmitter 250 is further configured to transmit a client identifier to the server, where the client identifier associates the transmitted wire format data with the client (i.e., creates a profile identifier for the client or user of the client device for reference at the server. The client identifier may include, for example, a reference number, the name of the client, or a number-digit identifier, as non-limiting examples. The transmitter 250 may further be configured to transmit the wire format data, where the wire format data includes at least one of client identification information, a command, and a transaction amount. Examples of the client identification information and the command were discussed above.

In various embodiments of the invention, the memory 210, receiver 230, the processor 240, and the transmitter 250 are configured/implemented as various combinations of hardware, firmware, and software embodied on a non-transitory computer-readable medium or computer-readable storage medium. Accordingly, the apparatus 200 is configured to convert a print stream of data for a client received in a print protocol, enabling the apparatus 200 to acquire data for processing the financial account for the client from various computer applications without the need for the integration of additional hardware and customized software components into the apparatus 200.

FIG. 3 shows a flow diagram of a method for acquiring data for processing a financial account, in accordance with an embodiment of the invention. In accordance with an embodiment of the invention, the method 300 includes receiving, at step 310, a request to process the financial account. The request includes a print stream of data for a client received in a print protocol. At step 320, the method further includes converting the print stream of data into wire format data. Further, the method includes transmitting, at step 330, the wire format data to a server to process the financial account.

Receiving, at step 310, may include receiving the request to process the financial account, where the financial account includes one of a bank account, a prepaid card account, a payroll account, a debit card account, and a credit card account.

Receiving, at step 310, may include receiving the request, where the request further includes at least one of a command and a transaction amount. In accordance with an embodiment of the invention, the command includes an instruction to generate a new financial account, modify the financial account, load funds into the financial account, or close the financial account.

Transmitting, at step 330, may include transmitting a client identifier to the server, where the client identifier associates the transmitted wire format data with the client. The transmitting may further include transmitting the wire format data using an encrypted communication protocol, such as a SSL or TLS, as non-limiting examples.

In accordance with another embodiment of the invention, transmitting, at step 330, may include transmitting the wire format data, where the wire format data includes at least one of client identification information, a command, and a transaction amount. Examples of the client identification information and the command were discussed above.

FIG. 4 shows a block diagram of another apparatus, in accordance with an embodiment of the invention. The apparatus 400 may include, for example, a host server as discussed above (e.g., host server 120). In accordance with an embodiment of the invention, the apparatus 400 includes an application 410 including computer program code 420. The computer program code 420 may be embodied on a non-transitory computer readable storage medium. The apparatus also includes a receiver 430, an extractor 440, and a processor 450 for processing information and executing instructions or operations. The application 410 may be coupled to the processor 450 for storing information and instructions to be executed by the processor 450. The computer program code 420 may be encoded with instructions to control the receiver 430, the extractor 440, and the processor 450 to perform a process, such as the method shown in FIG. 4, as was discussed in detail above.

While a single application 410, receiver 430, extractor 440, and processor 450 are shown in FIG. 4, multiple databases, receivers, extractors, and processors may be utilized according to other embodiments of the invention.

In accordance with an embodiment of the invention, the receiver 430 is configured to receive a request to process a financial account. The request includes wire format data for a client. As previously discussed, the financial account may include one of a bank account, prepaid card account, a payroll account, a debit card account, and a credit card account. The data is in the form of encrypted wire format data which has been converted from a print stream of data for the client device 110 received in a print protocol. As previously discussed, the received data may include, for example, the client identification information including at least one of the client's name, address, date of birth, social security number, or phone number, as non-limiting examples.

The extractor 440 is configured to extract data elements from the received wire format data. The processor 450 is configured to process the financial account using the extracted data elements.

The receiver 430 is further configured to receive the wire format data using an encryption communication protocol, such as a SSL or TLS, as non-limiting examples. The extractor 440 is further configured to identify the data elements to extract from the received wire format data based on a client identifier, as discussed above. The processor 450 is further configured to process the financial account using the extracted data elements, where the extracted data elements include at least one of client identification information, a command, and a transaction amount. As discussed above, the command includes an instruction to generate a new financial account, modify the financial account, load funds into the financial account, or close the financial account.

In accordance with an embodiment of the invention, the processor 450 includes an API to which the extracted data elements are submitted to process the financial account, for example, to generate the new financial account, modify the existing financial account, load funds into the existing financial account, or cancel the existing financial account.

FIG. 5 shows a flow diagram of a method for processing a financial account, in accordance with an embodiment of the invention. In accordance with an embodiment of the invention, the method 500 includes receiving, at step 510, a request to process the financial account, where the request includes wire format data for a client. In this embodiment of the invention, the wire format data for the client includes the encrypted wire format data which has been converted from a print stream of data for the client received in a print protocol. Data elements are extracted, at step 520, from the received wire format data. The financial account is processed, at step 530, using the extracted data elements.

In accordance with an embodiment of the invention, receiving, at step 510, includes receiving the request, where the request includes one of a bank account, a prepaid card account, a payroll account, a debit card account, and a credit card account. Receiving, at step 510, may further include receiving the wire format using an encryption protocol, as discussed above for the embodiment shown in FIGS. 2 and 3.

Extracting, at step 520, may include identifying the data elements to extract from the received wire format data based on a client identifier.

In accordance with another embodiment of the invention, processing, at step 530, includes using the extracted data elements, where the data elements include at least one of client identification information, a command, and a transaction amount. As previously discussed above for another embodiment, the command includes an instruction to generate a new financial account, modify the financial account, load funds into the financial account, or close the financial account.

In accordance with another embodiment of the invention, there is provided an apparatus and a method for processing a financial statement, where the print stream of data is not converted to wire format data before being transmitted to the host server. For example, the method includes receiving a request to process the financial account. The request includes a print stream of data for a client received in a print protocol. The method further includes transmitting the print stream of data to a server to process the financial account. The server receives the print stream of data from the client device 110 and extracts data elements from the received print stream of data. The financial account is processed using the extracted data elements.

Some of the many advantages of embodiments of the invention include accepting user data from databases of any computer application that is capable of printing, i.e., using a printing protocol function. Additional advantages of embodiments of the invention include ease of deployment and low/zero maintenance for the client. Furthermore, some embodiments of the invention require no special connectivity requirements on for the client, with the exception of a standard outbound encryption protocol, such as a secure socket layer connection. Certain embodiments of the invention provide the user with the flexibility to support many different formats of data management and different account activities (i.e., create a new financial account, modify a financial account, load funds into the financial account, or close the financial account).

In accordance with another embodiment of the invention, the apparatus 400 may further include a web-based, graphical user interface 460 through which the client or a user of the client device 110 manages the processing of the financial account.

For example, the processor 450 is configured to provide the client or user of the client device 110 (hereinafter used interchangeably as “the client” or “the user”) with the graphical user interface 460 for providing user management, processing the financial account, processing a financial account inquiry, cancelling the financial account, viewing transaction history for the financial account, and providing administrative features.

Account Processing

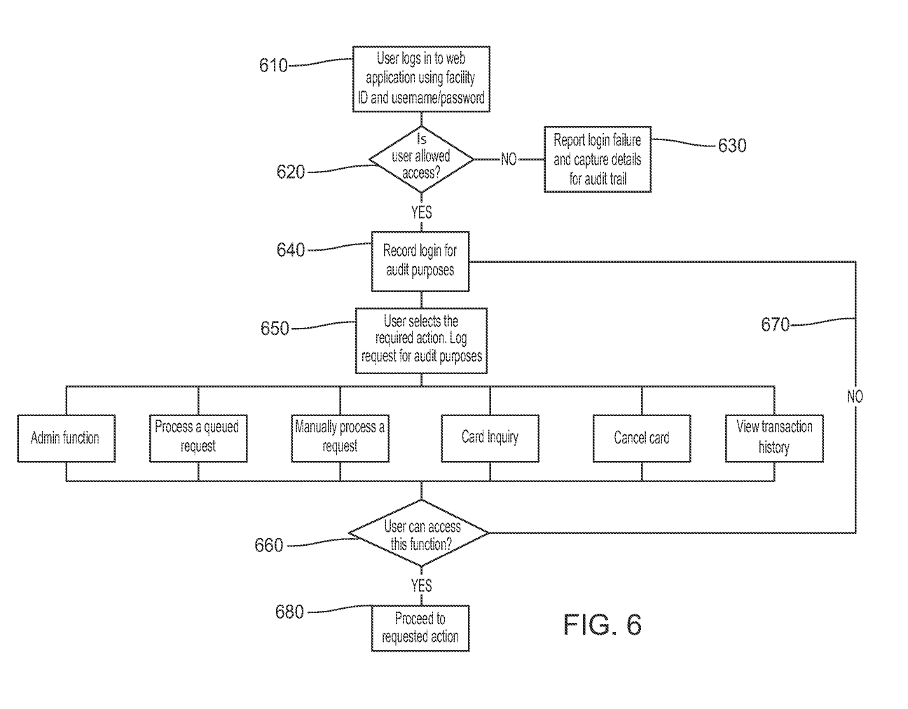

FIG. 6 shows a flow diagram of another method for processing a financial account, in accordance with an embodiment of the invention. At step 610, the graphical user interface 460 presents a login screen for the user to enter a “username,” “password,” and facility identification number (ID). The method further includes verifying, at step 620, whether the user is allowed access, based on a comparison of the “username,” “password,” and facility ID with a list of authorized users, to the host server 120 to process the financial account. The list of authorized users may be stored in application 410 of the host server 120 or stored remotely at one or more other devices. If the user is not allowed access, the graphical user interface 460 notifies, at step 630, the user, and the processor 450 is configured to generate a report for audit purposes. If the user is allowed access, the processor 450 is configured to record, at step 640, the login for audit purposes.

If access is granted, the user selects, at step 650, the selected action which is recorded for audit purposes. In accordance with an embodiment of the invention, the selected action includes, for example, performing an administrative function, processing a queued request, manually processing a request, processing a financial account inquiry, canceling a financial account, or viewing the transaction history of the financial account, as will be discussed in more detail below. Once the user selects, at step 650, the selected action, the processor 450 is further configured to verify, at step 660, that the user has access to perform the selected action using the same method as described above in step 620. If the user is not allowed access, the graphical user interface 460 notifies, at step 670, the user, and the processor 450 is configured to generate a report for audit purposes. If the user is allowed access to the selected action, then the processor 450 is configured to proceed, at step 680, with the selected action.

In accordance with an embodiment of the invention, the processing of the financial account, as shown in FIG. 6, provides a secure login based on the user and their defined roles, and the ability for the end-user to receive the next request from the queue or to enter all the details manually if a manual process is being followed. For a queued request, the data will be retrieved from the application 410 and displayed on the graphical user interface 460, while for a manual process the data will be manually entered. Certain embodiments of the invention further provide an input field for a financial account package number which may be entered using a barcode scanner or manually entered for processing. Some embodiments further provide confirmation of the data at each step in the method shown in FIG. 6 and two final confirmations that the information is correct before allowing the user to submit the data for processing the financial account. Certain embodiments of the invention provide a printed receipt for a transaction showing the name, facility ID, amount, and card package number, and a full audit trail logging where each transaction performed by the user was successful or unsuccessful.

User Management Features

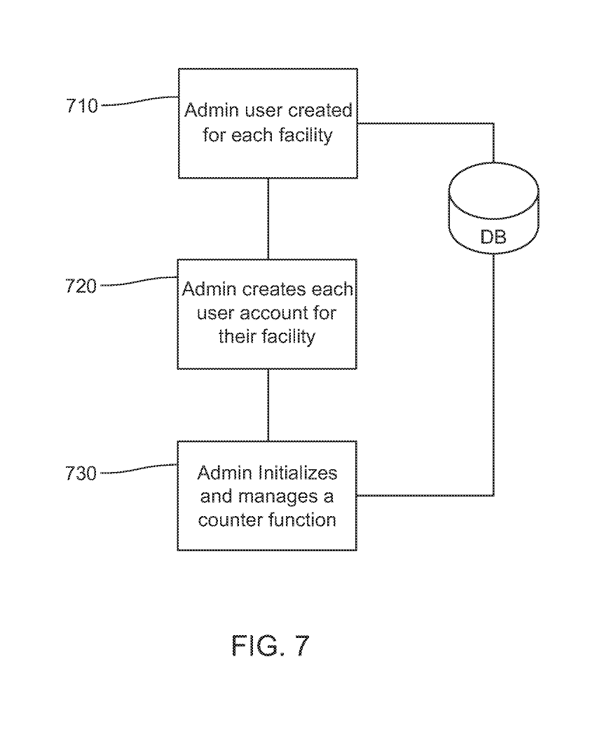

FIG. 7 shows a schematic diagram of user management features, in accordance with an embodiment of the invention. As shown in FIG. 7, using user management features of the apparatus 400, an administrator may access the host server 120 through the client device 110 to create an administrator account for a facility 710, such as a business, a jail, or a banking institution, as non-limiting examples. The facility administrator will be responsible for creating and managing new clients or users 720, assigning access to new clients or users, resetting passwords, and terminating client or user accounts. The facility administrator may also be responsible for initializing and managing a counter function 730, where an independent number associated with a client's own internal control number is assigned, for example, a next available check stock number for the purpose of reconciling the apparatus, for example in conjunction with step 650 described above, to the client's own financial control numbering system. This numbering function is specific to databases and financial systems where sequential or algorithmic process numbering is used for protecting data integrity and financial security preventing fraud and data integrity. This numbering is generated by the counter function 730 of the user management features and may be controlled through the graphical user interface 460 by only the facility administrator to correctly control the numbering of transaction events. The independent number may be incremented, for example, when a new card is successfully issued. The numbering is always retained in the DB in the counter function 730 for cards that are cancelled so that an audit trail would always exist linking this numbering from the apparatus 400 to the issued card to leave the reconciliation and audit functions in tact.

Processing a Queued Request

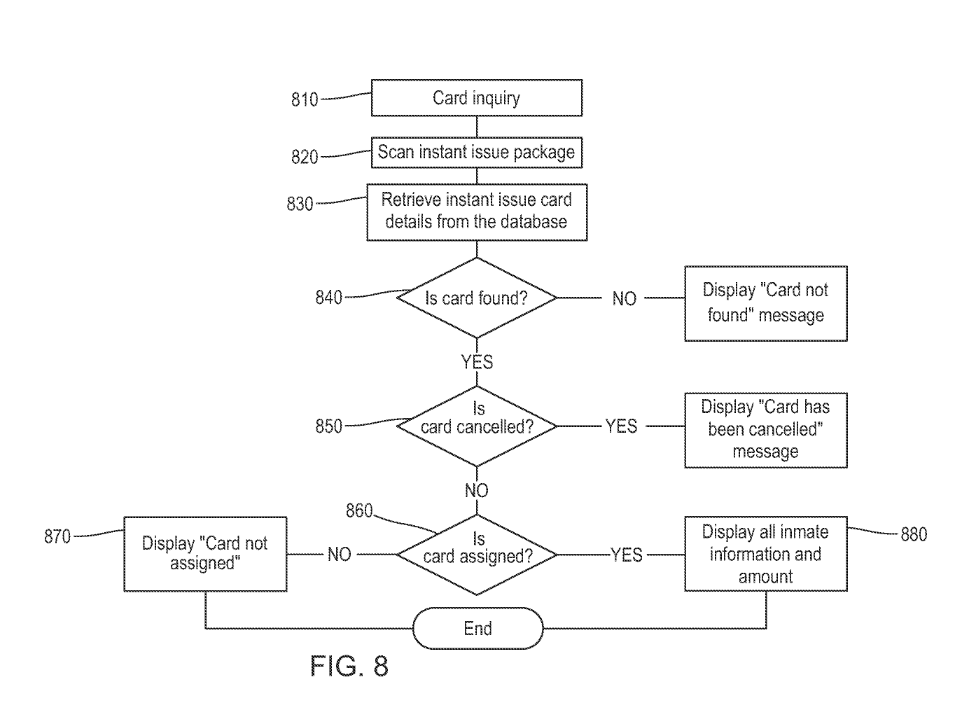

FIG. 8 shows a flow diagram of a method for processing a queued request, in accordance with an embodiment of the invention. As discussed above, every transaction/step of the method shown in FIG. 8 generates a report for audit purposes. In accordance with an embodiment of the invention, the method includes scanning, at step 810, an identification label (i.e., a packaging label) associated with the financial account either using a barcode scanner or by manually entering the data, to determine if it has already been assigned to a user. The method further includes retrieving, at step 820, instant issue financial account details from application 410 or stored remotely at one or more other devices to determine if information associated with the identification label is stored in application 410 or stored remotely. If the financial account details are not retrieved (i.e., the instant issue financial account details were not confirmed), the graphical user interface 460 notifies, at step 830, the user. If the financial account details retrieved, the method further includes, verifying, at step 840, that the financial account has not been cancelled. If the financial account has been cancelled, the graphical user interface 460 notifies, at step 850, the user. If the financial account has not been cancelled, the method further includes verifying, at step 860, whether the financial account has already been assigned to a user. If the financial account has not been assigned to a user, then the graphical user interface 460 notifies, at step 870, the user. If the financial account has been assigned to a user, then the graphical user interface 460 displays, at step 880, all information associated with the assigned user.

Financial Account Cancellation

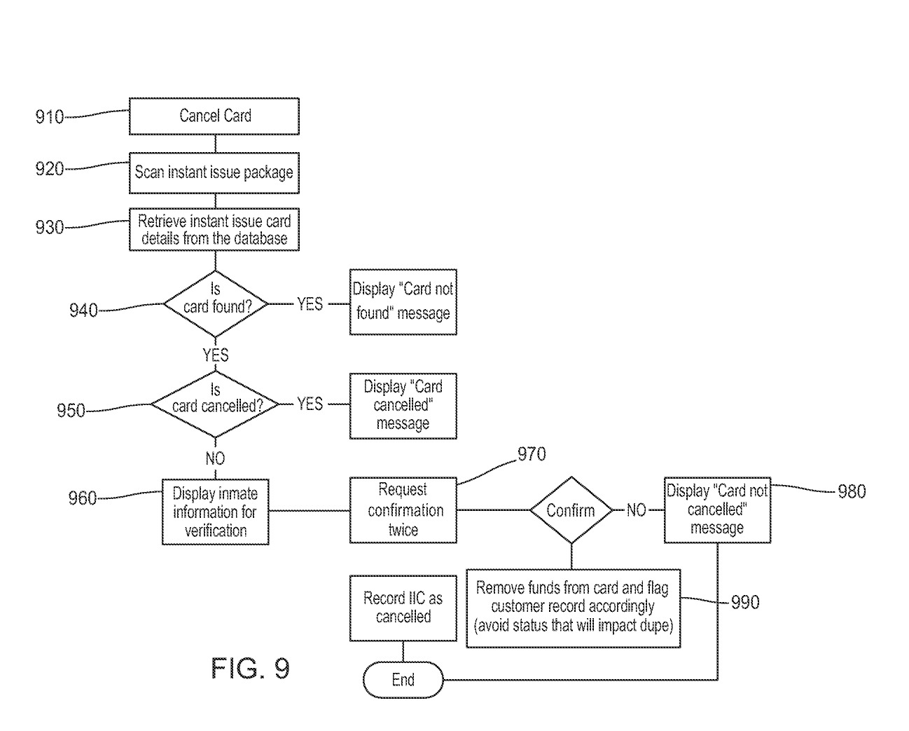

FIG. 9 shows a flow diagram of a method for cancelling a financial account, in accordance with an embodiment of the invention. In this method, steps 910-950 may be identical to steps 810-850 shown in FIG. 8, and therefore the description for these steps discussed above are not repeated for brevity purposes. If the financial account has not been cancelled, the method further includes displaying, at step 960, all information associated with the assigned user to confirm that the user wants to cancel the financial account. Confirmation is provided twice by the graphical user interface 460 (step 970). If confirmation is not received from the user to cancel the financial account, the graphical user interface 460 notifies, at step 980, the user. If confirmation is received from the user to cancel the financial account, any funds in the financial account are removed, at step 990, and the graphical user interface notifies the user. In step 995, if a financial account issued and subsequently needs to be cancelled, the processor 450 cancels the financial account.

Further to the description above for embodiments of the invention shown in FIGS. 2-9, the processors 240, 450 may be of any type suitable to the local technical environment, and may include one or more of general purpose computers, special purpose computers, microprocessors, digital signal processors (DSPs), and processors based on multi-core processor architecture, as non-limiting examples. The computer program code 220, 420 according to certain embodiments of the invention, may be composed of modules that are in operative communication with one another, and which are designed to pass information or instructions to an electronic device.

The memory 210 and database 410 may be of any type suitable to the local technical environment and may be implemented using any suitable data storage technology, machine or computer readable storage medium, such as semiconductor-based memory devices, flash memory, magnetic memory devices and systems, optical memory devices and systems, fixed memory and removable memory, as non-limiting examples.

The embodiments of the invention discussed above may be implemented by hardware, computer software executable by the processors 240, 450, or by a combination of hardware and software.

The software and/or hardware may reside on the processors 240, 450 or other electronic devices. If desired, part of the software and/or hardware may reside on the processors 240, 450 and part of the software and/or hardware on other electronic devices. In an embodiment of the invention, software, or an instruction set may be maintained on any one of various conventional computer-readable medium or computer-readable storage medium.

The steps of the methods, as shown in FIGS. 3 and 5-8 described in connection with the embodiments disclosed herein can be embodied directly in hardware, in the computer program code executed by the processors 240, 450, or in a combination of the two. The computer program code 220, 420, or product, can be embodied on a computer readable (i.e., non-transitory) storage medium. Non-transitory storage medium does not include a transitory signal. Examples of non-transitory storage medium may include, for example, a computer-readable medium, a computer distribution medium, a computer-readable storage medium, and a computer program. The computer readable storage medium may include any media or means that may contain, store, communicate, propagate or transport the instructions for use by or in connection with an instruction execution system, apparatus, or device, for example, a disk media, computer memory, or other storage device. For example, the computer program code 220, 420 can reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. The storage medium can be coupled to the processors 240, 450 such that the processors 240, 450 can read information from, and write information to, the storage medium. In the alternative, the storage medium can be integral to the processors 240, 450. The processors 240, 450 and the storage medium can reside in an application specific integrated circuit (ASIC). In the alternative, the processors 240, 450 and the storage medium can reside as discrete components.

Thus, in accordance with an embodiment of the invention, there is provided a computer program product embodied on a non-transitory computer readable storage medium. The computer program product is encoded with instructions to control a processor to perform a process for acquiring data to process a financial account. The process includes receiving a request to process the financial account. The request includes a print stream of data for a client received in a print protocol. The process further includes converting the print stream of data into wire format data. Further, the process includes transmitting the wire format data to a server to process the financial account.

Furthermore, in accordance with another embodiment of the invention, there is also provided another computer program product embodied on a non-transitory computer readable storage medium. This computer program product is encoded with instructions to control a processor to perform a process for processing a financial account. The process includes receiving a request to process the financial account. The request includes wire format data for a client. The process further includes extracting data elements from the received wire format data, and processing the financial account using the extracted data elements. The receiving includes receiving encrypted wire format data which has been converted from a print stream of data for the client received in a print protocol.

One having ordinary skill in the art will readily understand that the invention as discussed above may be practiced with steps in a different order, and/or with hardware elements in configurations which are different than those which are disclosed. Therefore, although the invention has been described based upon these preferred and non-limiting embodiments, it would be apparent to those of skill in the art that certain modifications, variations, and alternative constructions would be apparent, while remaining in the spirit and scope of the invention. Thus, the example embodiments do not limit the invention to the particular listed devices and technologies. In order to determine the metes and bounds of the invention, therefore, reference should be made to the appended claims.

We claim:

1. A method for acquiring data to process a financial account, the method comprising:
receiving a request to process the financial account, wherein the request comprises a print stream of data for a client received in a print protocol;
converting, using a processor, the print stream of data into wire format data; and
transmitting the wire format data to a server to process the financial account.

2. The method of claim 1, wherein the receiving comprises receiving the request to process the financial account comprising one of a bank account, a prepaid card account, a payroll account, a debit card account, and a credit card account.

3. The method of claim 1, wherein the receiving comprises receiving the request further comprising at least one of a command and a transaction amount, wherein the command comprises an instruction to generate a new financial account, modify the financial account, load funds into the financial account, or close the financial account.

4. The method of claim 1, further comprising:
transmitting a client identifier to the server, wherein the client identifier associates the transmitted wire format data with the client.

5. The method of claim 1, wherein the transmitting further comprises transmitting the wire format data using an encryption protocol.

6. The method of claim 1, wherein the transmitting further comprises transmitting the wire format data comprising at least one of client identification information, a command, and a transaction amount, wherein the command comprises an instruction to generate a new financial account, modify the financial account, load funds into the financial account, or close the financial account.

7. An apparatus, comprising:
a receiver configured to receive a request to process a financial account, wherein the request comprises a print stream of data for a client received in a print protocol;
a processor configured to convert the print stream of data into wire format data; and
a transmitter configured to transmit the wire format data to a server to process the financial account.

8. The apparatus of claim 7, wherein the receiver is further configured to receive the request to process the financial account comprising one of a bank account, a prepaid card account, a payroll account, a debit card account, and a credit card account.

9. The apparatus of claim 7, wherein the receiver is further configured to receive the request further comprising at least one of a command and a transaction amount, wherein the command comprises an instruction to generate a new financial account, modify the financial account, load funds into the financial account, or close the financial account

10. The apparatus of claim 7, wherein the transmitter is further configured to transmit a client identifier to the server, wherein the client identifier associates the transmitted wire format data with the client.

11. The apparatus of claim 7, wherein the transmitter is further configured to transmit the wire format data using an encryption protocol.

12. The apparatus of claim 7, wherein the transmitter is further configured to transmit the wire format data comprising at least one of client identification information, a command, and a transaction amount, wherein the command comprises an instruction to generate a new financial account, modify the financial account, load funds into the financial account, or close the financial account.

13. An apparatus, comprising:
receiving means for receiving a request to process a financial account, wherein the request comprises a print stream of data for a client received in a print protocol;
processing means for converting the print stream of data into wire format data; and
transmitting means for transmitting the wire format data to a server to process the financial account.

14. A method for processing a financial account, the method comprising:
receiving a request to process the financial account, wherein the request comprises wire format data for a client;
extracting data elements from the received wire format data; and
processing the financial account using the extracted data elements,
wherein the receiving comprises receiving encrypted wire format data which has been converted from a print stream of data for the client received in a print protocol.

15. The method of claim 14, wherein the receiving further comprises receiving the request to process the financial account comprising one of a bank account, a prepaid card account, a payroll account, a debit card account, and a credit card account.

16. The method of claim 14, wherein the receiving further comprises receiving the wire format data using an encryption protocol.

17. The method of claim 14, wherein the extracting comprises identifying the data elements to extract from the received wire format data based on a client identifier.

18. The method of claim 14, wherein the processing comprises processing the financial account using the extracted data elements comprising at least one of client identification information, a command, and a transaction amount, wherein the command comprises an instruction to generate a new financial account, modify the financial account, load funds into the financial account, or close the financial account.

19. An apparatus, comprising:
a receiver configured to receive a request to process a financial account, wherein the request comprises wire format data for a client;
an extractor configured to extract data elements from the received wire format data; and
a processor configured to process the financial account using the extracted data elements,
wherein the data comprises encrypted wire format data which has been converted from a print stream of data for the client received in a print protocol.

20. The apparatus of claim 19, wherein the receiver is further configured to receive the request to process the financial account comprising one of a bank account, a prepaid card account, a payroll account, a debit card account, and a credit card account.

21. The apparatus of claim 19, wherein the receiver is further configured to receive the wire format data using an encryption protocol.

22. The apparatus of claim 19, wherein the extractor is further configured to identify the data elements to extract from the received wire format data based on a client identifier.

23. The apparatus of claim 20, wherein the processor is further configured to process the financial account using the extracted data elements comprising at least one of client identification information, a command, and a transaction amount, wherein the command comprises an instruction to generate a new financial account, modify the financial account, load funds into the financial account, or close the financial account.

24. An apparatus, comprising:
receiving means for receiving a request to process a financial account, wherein the request comprises wire format data for a client;
extracting means for extracting data elements from the received wire format data; and
processing means for processing the financial account using the extracted data elements,
wherein the data comprises encrypted wire format data which has been converted from a print stream of data for the client received in a print protocol.

25. A computer program product embodied on a non-transitory computer readable storage medium, the computer program product being encoded with instructions to control a processor to perform a process for acquiring data to process a financial account, the process comprising:
receiving a request to process the financial account, wherein the request comprises a print stream of data for a client received in a print protocol;
converting, using a processor, the print stream of data into wire format data; and
transmitting the wire format data to a server to process the financial account.

26. A computer program product embodied on a non-transitory computer readable storage medium, the computer program product being encoded with instructions to control a processor to perform a process for processing a financial account, the process comprising:
receiving a request to process the financial account, wherein the request comprises wire format data for a client;
extracting data elements from the received wire format data; and
processing the financial account using the extracted data elements,
wherein the receiving comprises receiving encrypted wire format data which has been converted from a print stream of data for the client received in a print protocol.
